(19) United States
(12) Patent Application Publication
(10) Pub. No.: US 2013/0031047 A1
(43) Pub. Date: Jan. 31, 2013

(54) EFFICIENCY AND ACCURACY OF GEO-FENCING BASED ON USER HISTORY

(71) Applicants: Ronen Boazi, Binyamina (IL); Benny Schlesinger, Ramat Hasharon (IL)

(72) Inventors: Ronen Boazi, Binyamina (IL); Benny Schlesinger, Ramat Hasharon (IL)

(73) Assignee: MICROSOFT CORPORATION, Redmond, WA (US)

(21) Appl. No.: 13/192,461

(22) Filed: Jul. 28, 2011

(51) Int. Cl. G06F 17/30

(52) U.S. Cl. 707/609; 707/E17.018

(57) ABSTRACT

Architecture that identifies and learns repeated user behavior (habits) related to routes of travel and points of interest. Once learned, the habits of an individual can be used to make an algorithm more efficient, and hence, the user experience of an application more effective and enjoyable. The capability to more accurately infer user behavior based on user history can be employed to operate (e.g., power down or place in components standby to conserve power) user device resources in a more efficient manner. It can be identified that a user has deviated from a routine route that has associated points of interest to a new route that has associated new points of interest. Once identified, the original set of points of interest for the routine route is then updated with new points of interest. The identification of fixed routes can be determined dynamically as well as deviation from a fixed route.

### BACKGROUND

Oftentimes users have fixed routes that are traveled and routines that are repeated on a regular basis. This flows from that fact that users develop habits that are repeated with some degree of likelihood such as repeatedly sleeping at the same travel locations, working in the same office, shopping at similar locations, and so on. However, in many cases, this information is not utilized in ways that can enhance the user experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture identifies repeated user behavior related to routes of travel and points of interest. Oftentimes users have fixed routes that are traveled and routines that are repeated on a regular basis. Over time, these individual habits (also referred to a routines) such as routinely traveled routes, etc., can be learned as a user history. Once learned, the habits of an individual can be used to make an algorithm more efficient, and hence, the user experience of an application more effective and enjoyable.

In other words, it can be detected that a user has deviated from a routine route that has associated points of interest to a new route that has associated new points of interest. Once detected, the original set of points of interest for the routine route is then updated with new points of interest.

For example, geo-fencing algorithms frequently maintain a balance between accuracy and available resources (e.g., battery power). A geo-fence is a predefined virtual perimeter (e.g., within a two mile radius) of a physical geographic area or point of interest. When the geo-location (geographic location) of a user device (e.g., mobile device) matches the geo-location information (e.g., latitude-longitude coordinates) that defines the virtual perimeter, predetermined events can be triggered to occur, such as sending a notification to the user of the user device, via the user device or another device.

Additionally, the capability to more accurately infer user behavior based on user history can be employed to operate (e.g., power down or place in components standby to conserve power) user device resources in a more efficient manner.

In one specific implementation, the architecture identifies fixed routes and mathematically calculates which points of interest will not consume resources as long as the user is moving on a specific fixed route.

Accordingly, the architecture identifies user habits relative at least to fixed routes of travel over time. The identification of fixed routes based on given possible routes can be determined dynamically according to current user location, direction (or heading), and/or time. Additionally, that architecture enables dynamic identification if the user exits a fixed route. Based on the identified route or route segments, an algorithm modifies priority of points of interest based on the identified route or route segment.

In addition to conserving power by eliminating geo-fences that are not along the current route, the same principles can be applied to improve the accuracy at least in terms of predicting when a user is likely to trigger a certain geo-fence (e.g., based on his route history) and then proactively activate (power on) a geolocation technology (e.g., global positioning system (GPS)) at approximately an optimum time to accurately detect when to trigger each geo-fence. (Leaving the GPS continuously activated is unfeasible because it drains the device battery).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system of improving geo-fencing in accordance with the disclosed architecture.

FIG. 2 illustrates an alternative embodiment of a system for improving geo-fencing.

FIG. 3 illustrates an example city street layout having streets and avenues that facilitate access to a point of interest.

FIG. 4 illustrates a method of improving geo-fencing in accordance with the disclosed architecture.

FIG. 5 illustrates further aspects of the method of FIG. 4.

FIG. 6 illustrates an alternative method of improving geo-fencing.

FIG. 7 illustrates further aspects of the method of FIG. 6.

FIG. 8 illustrates a block diagram of a computing system that executes improved geo-fencing in accordance with the disclosed architecture.

### DETAILED DESCRIPTION

In many cases, users have only so many fixed geographical routes of travel that can be used on a regular basis to get to specific points of interest (e.g., store, gas station, entertainment venue, etc.). The disclosed architecture identifies these fixed routes and then monitors travel on one or more of these fixed routes to identify a repeated route of travel to a point of interest. In other words, in any typical city, there can be multiple streets, freeways, avenues, etc., that can be taken in which to get to a point of interest (e.g., a gas station).

The disclosed architecture identifies the fixed routes and repeated routes of travel for a given point of interest based on user behavior (user actions), and this can be determined over time. Additionally, identification of a fixed route and then repeated route can be determined dynamically based on given possible routes according to the current user heading, and user location, and/or time. It is also the case where identification occurs dynamically if user exits (deviates, diverts) the fixed route and/or repeated route of travel. Moreover, an algorithm is provided that modifies priority of a geo-fence (and associated point of interest) based on the identified route. In yet another aspect, the architecture provides optimization to resource usage by computing which geo-fences (hence, points of interest) should not consume resources as long as the user is moving on a specific route. This provides increased accuracy and saves on battery power.

The architecture can employ existing geo-fencing solutions, which are then extended to be more efficient with resources and dynamicism. This can be accomplished by learning or identifying user habits. Once known about a given user, this information can be utilized to make related algorithms more efficient.

For example, a user drives on a route that will lead to point of interest. Geo-fencing will work as usual without any changes. However, as the user drives on a known route that will not lead to a given point of interest, the point of interest will be removed from the monitored list thus saving resources and preventing potential false alarms. As the user drives on a route that will not lead to the point of interest, the algorithm removes the unneeded point of interest from the monitored list. Once the user diverts from the known route the geo-fencing algorithm reviews whether this is another known route. If so, the algorithm will continue to monitor only the expected point of interest. If the route is unknown, the algorithm will use the generic algorithm.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

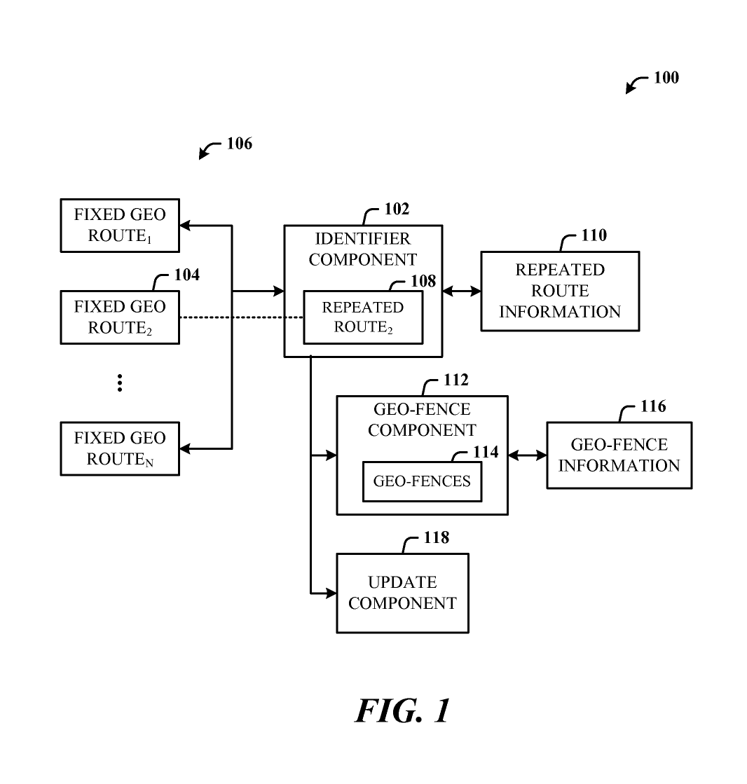

FIG. 1 illustrates a system 100 of improving geo-fencing in accordance with the disclosed architecture. The system 100 includes an identifier component 102 that identifies a fixed geographical (geo) route 104 (of a set of fixed routes 106) is a repeated route 108 of travel based on repeated user travel related to the fixed route 104. The repeated route 108 can be defined according to repeated route information 110. A geo-fence component 112 manages geo-fences 114 associated with the repeated route 108. The geo-fences 114 can be defined according to geo-fence information 116. An update component 118 updates the geo-fences 114 based on new or removed geo-fences along the repeated route.

Each of the geo-fences 114 is activated only at an appropriate time to conserve resources (e.g., processor cycles, memory, mass storage, communications packet traffic, etc.) in a user mobile device (e.g., a mobile phone). The geo-fence component 112 removes a geo-fence (of the geo-fences 114) associated with a point of interest from a monitored list of geo-fences (the geo-fences 114) when travel on the repeated route will not lead to the point of interest. The fixed geographical route 104 is identified from a group 106 of fixed routes based on at least one of user heading, user location, or time. The identifier component 102 dynamically identifies when travel deviates from the repeated route 108.

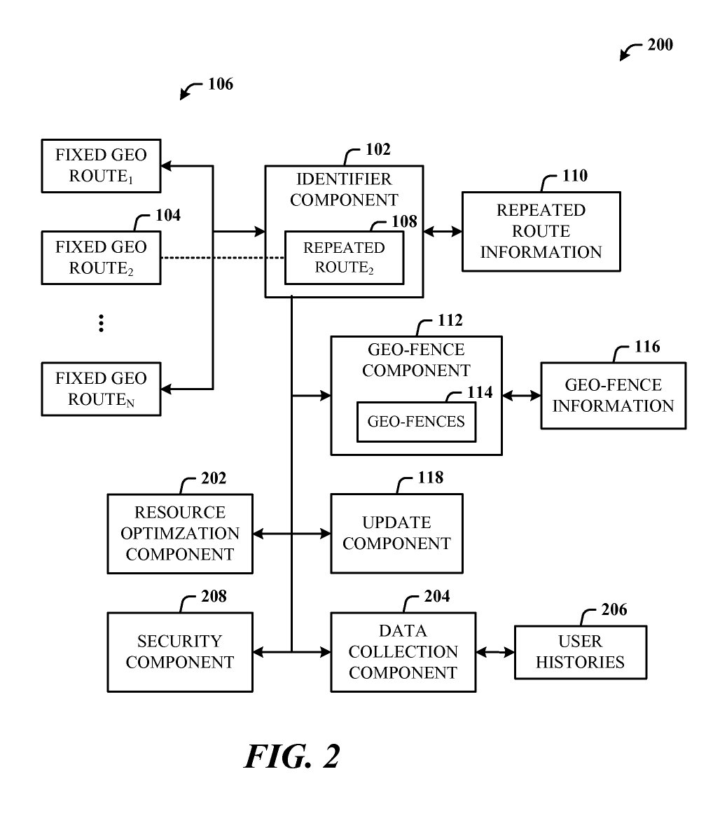

FIG. 2 illustrates an alternative embodiment of a system 200 for improving geo-fencing. The system 200 can include the entities (e.g., fixed geo route 104) and components (e.g., identifier component 102) of the system 100 of FIG. 1, as well as other components. For example, the system 200 can further comprise a resource optimization component 202 that activates a geo-fence (e.g., of the geo-fences 114) along the repeated route 108 only at an appropriate time, as travel progresses along the repeated route 108, to conserve resources of a user mobile device (e.g., mobile phone).

For example, if a point of interest is sufficiently distant from a usual (or repeated) route, it is a waste of resources to monitor the associated geo-fence when identifying travel on the usual route. These resources are wasted each time the user travels on that regular route, since the geo-fence is already known. If it is inferred that travel is on a usual route that will lead to the point of interest, the amount of monitoring can be reduced or even eliminated until travel is proximate or on the point of interest geo-fence. Thus, resource optimization can save battery energy, processor cycles, and other limited resources to provide the user a better experience (e.g., using the geo-fence component 112). In addition to conserving power by eliminating geo-fences that are not along the current route, the same principles can be applied to improve the accuracy at least in terms of predicting when a user is likely to trigger a certain geo-fence (e.g., based on his route history) and then proactively activate (power on) a geolocation technology (e.g., global positioning system (GPS)) at approximately an optimum time to accurately detect when to trigger each geo-fence.

Similarly, when the user is identified as traveling on a usual route, it can be computed when the user is likely to approach defined points of interest along that route, and then efficiently trigger the geo-fence at the right location and time.

The system 200 can also include a data collection 204 component that collects data to create user histories 206 related at least to the identification of the repeated route 108 and repeated user actions along the repeated route 108. In other words, if the user stops at multiple points of interest along the repeated route, these user actions can be information that is collected and stored as part of the user history for that route. Additionally, the geo-fences associated with the points of interest can be noted and stored, as well as dwell time at a point of interest, and any other information desired to be captured and stored such as arrival and departure heading, time, speed, etc. Some or all of this information can be analyzed to infer a routine by the user along the route. Analysis can further include computing the time-distance between geo-fences along a route, for example, for anticipated resource conservation optimization. In other words, if it is known (computed) that a second geo-fence is twenty minutes along a route from a first geo-fence, device resources can be managed according to reduce power consumption, and so on, during the interim travel between the geo-fences.

It is to be understood that where user information (e.g., identifying geo-location information) is collected, the user can be provided the option to opt-in to opt-out of allowing this information to be captured and utilized. Accordingly, a security component 208 can be provided which enables the user to opt-in and opt-out of identifying geolocation information as well as personal information that may have been obtained and utilized thereafter. The user can be provided with notice of the collection of information, for example, and the opportunity to provide or deny consent to do so. Consent can take several forms. Opt-in consent imposes on the user to take an affirmative action before the data is collected. Alternatively, opt-out consent imposes on the subscriber to take an affirmative action to prevent the collection of data before that data is collected. This is similar to implied consent in that by doing nothing, the user allows the data collection after having been adequately informed. The security component 208 ensures the proper collection, storage, and access to the user information while allowing for the dynamic selection and presentation of the content, features, and/or services that assist the user to obtain the benefits of a richer user experience and to access to more relevant information.

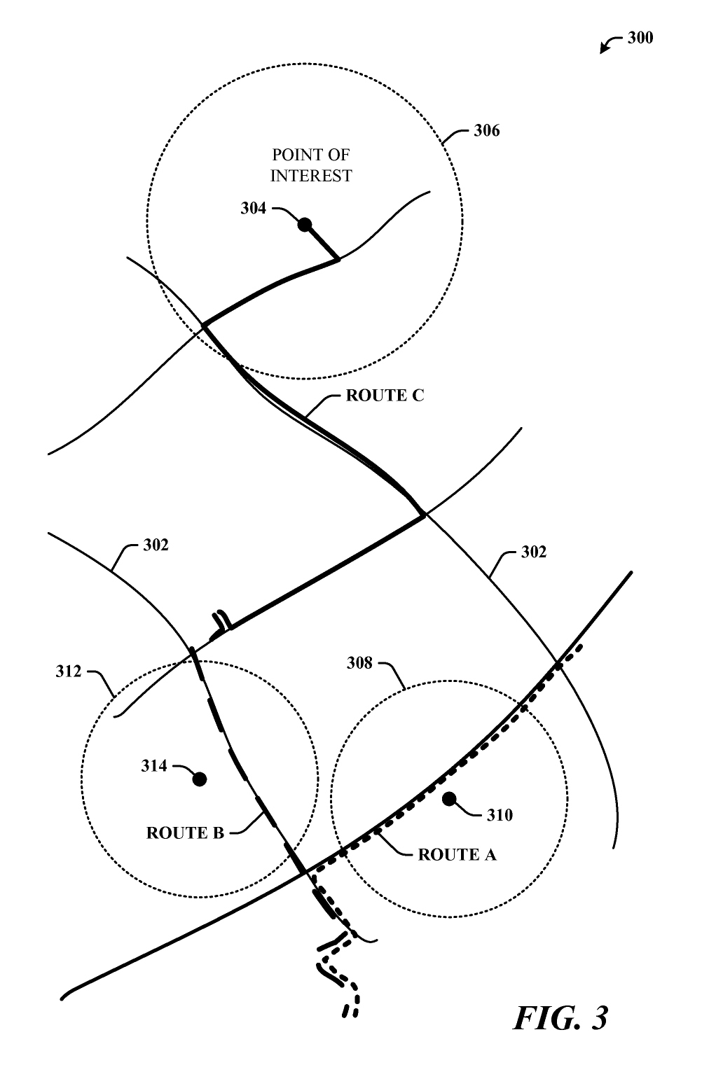

FIG. 3 illustrates an example city street layout 300 having streets and avenues 302 that facilitate access to a point of interest 304. Here, three routes are presented: a first route, Route A, a second route, Route B, and a third route, Route C. The disclosed architecture determines that Route A and Route B do not provide access to the point of interest 304. Thus, the point of interest 304 is not actively monitored when a user travels Route A or Route B, but only when traveling Route C that actually will result in reaching the point of interest 304.

The point of interest 304 has an associated geo-fence 306 (e.g., radius-based) on Route C. Additionally, Route A and Route B can have corresponding geo-fences for points of interest, such as a geo-fence 308 for a point of interest 310 on the Route A, and a geo-fence 312 for a point of interest 314 on Route B.

In terms of geo-fencing, the disclosed architecture determines that Route A and Route B do not include the geo-fence 306. Thus, the geo-fence 306 is not actively monitored when a user travels Route A or Route B, but only when traveling the Route C, which actually results in triggering the geo-fence 306.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

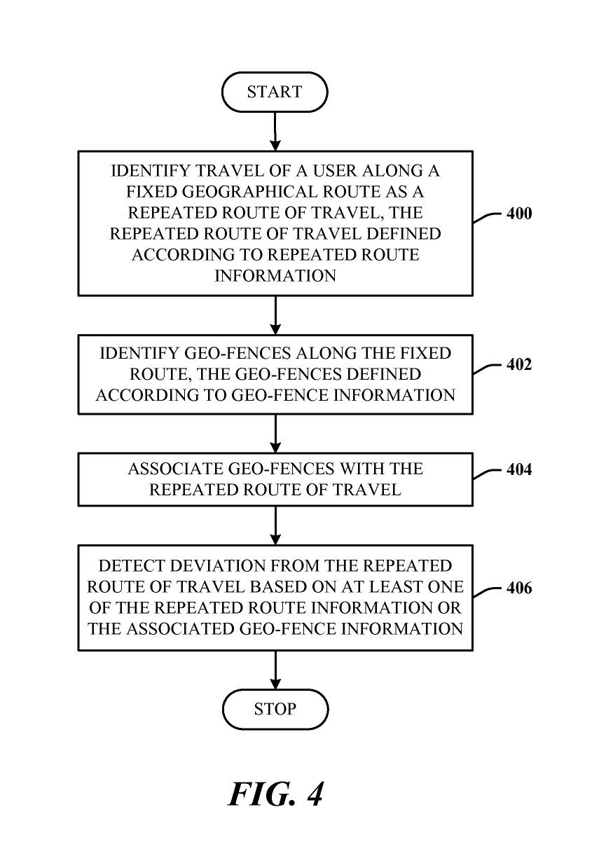

FIG. 4 illustrates a method of improving geo-fencing in accordance with the disclosed architecture. At 400, travel of a user along a fixed geographical route is identified as a repeated route of travel. The repeated route of travel is defined according to repeated route information. At 402, geo-fences are identified along the fixed route, the geo-fences defined according to geo-fence information. At 404, the geo-fences are associated with the repeated route of travel. At 408, deviation from the repeated route of travel is detected based on at least one of the repeated route information or the associated geo-fence information.

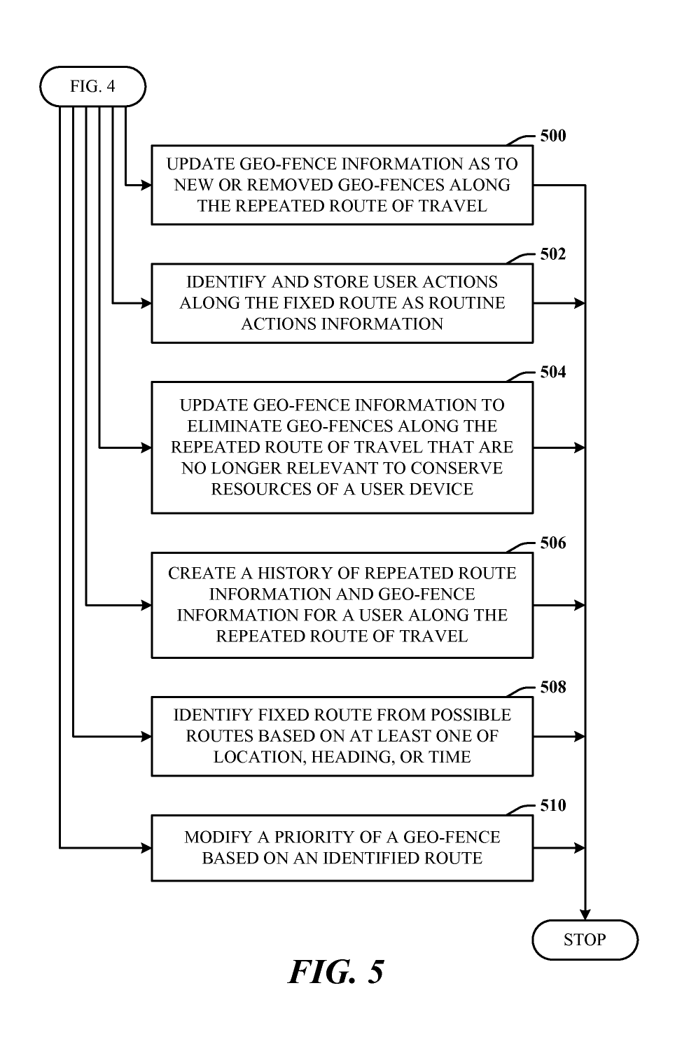

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, the geo-fence information is updated as to new or removed geo-fences along the repeated route of travel. At 502, user actions along the fixed route are identified and stored as routine actions information. At 504, the geo-fence information is updated to eliminate geo-fences along the repeated route of travel that are no longer relevant to conserve resources of a user device. At 506, a history of repeated route information and geo-fence information for a user along the repeated route of travel is created. At 508, the fixed route is identified from possible routes based on at least one of location, heading, or time. At 510, a priority of a geo-fence is modified based on an identified route.

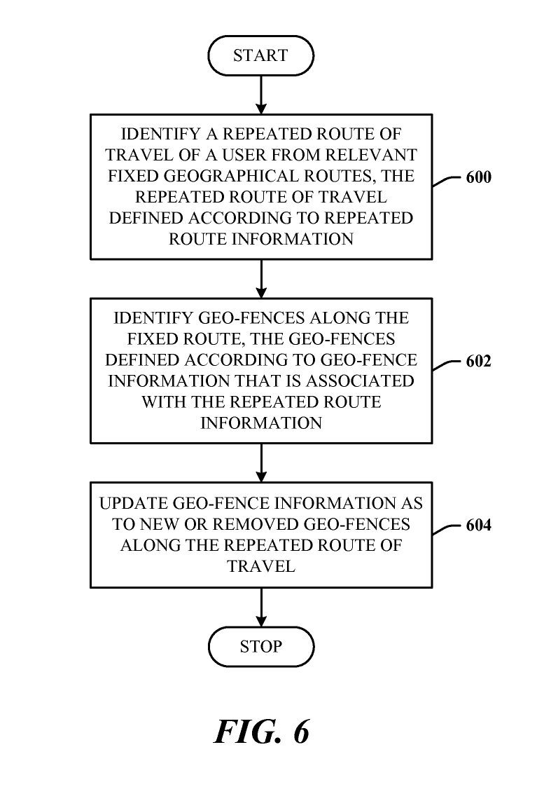

FIG. 6 illustrates an alternative method of improving geo-fencing. At 600, a repeated route of travel of a user is identified from relevant fixed geographical routes, the repeated route of travel defined according to repeated route information. At 602, geo-fences along the fixed route are identified, the geo-fences defined according to geo-fence information that is associated with the repeated route information. At 604, the geo-fence information is updated as to new or removed geo-fences along the repeated route of travel.

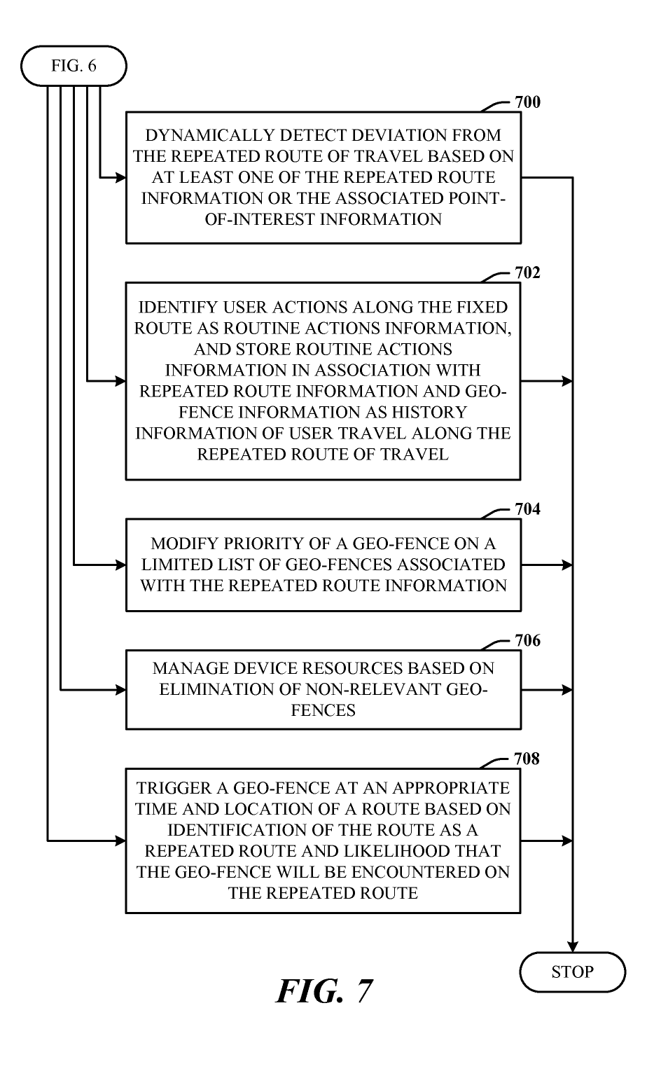

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, deviation from the repeated route of travel is dynamically detected based on at least one of the repeated route information or the associated point-of-interest information. At 702, user actions along the fixed route are identified as routine actions information, and the routine actions information is stored in association with repeated route information and geo-fence information as history information of user travel along the repeated route of travel. At 704, priority of a geo-fence is modified on a limited list of geo-fences associated with the repeated route information. At 706, device resources are managed based on elimination of non-relevant geo-fences. At 708, a geo-fence is triggered at an appropriate time and location of a route based on identification of the route as a repeated route and likelihood that the geo-fence will be encountered on the repeated route.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

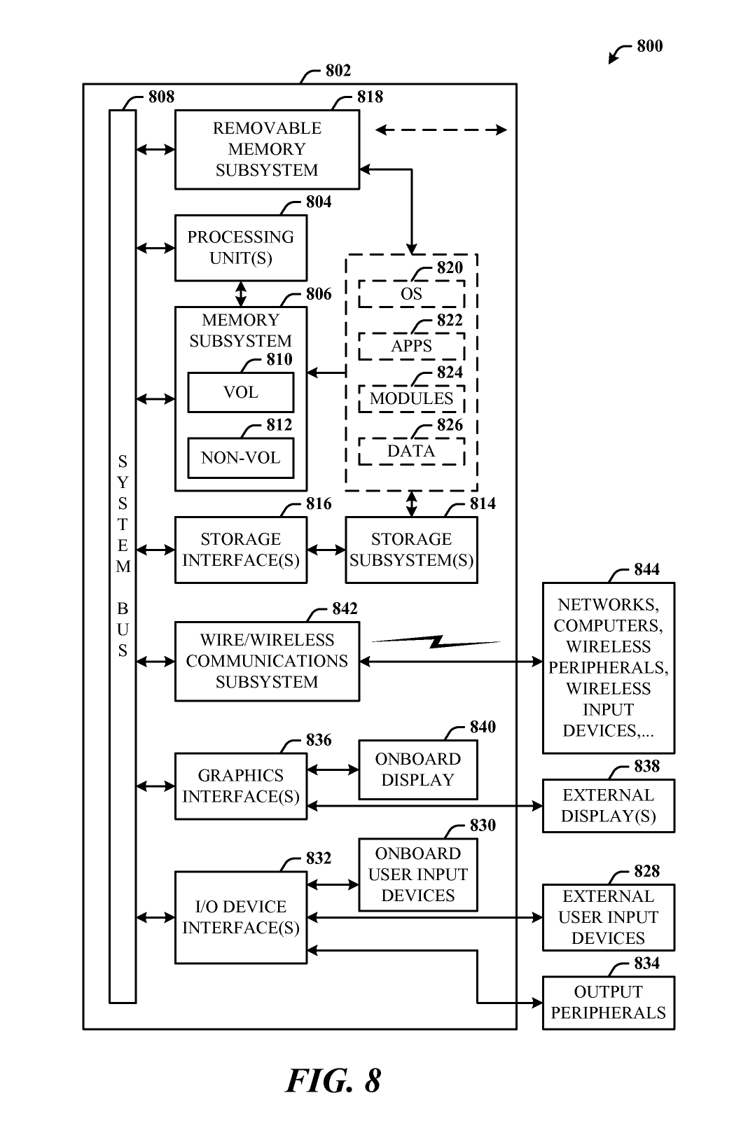

Referring now to FIG. 8, there is illustrated a block diagram of a computing system 800 that executes improved geo-fencing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, and the methods represented by the flowcharts of FIGS. 4-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
an identifier component that identifies a fixed geographical route is a repeated route of travel based on repeated user travel related to the fixed route, the repeated route defined according to repeated route information;
a geo-fence component that manages geo-fences associated with the repeated route, the geo-fences defined according to geo-fence information;
an update component that updates the geo-fences based on new or removed geo-fences along the repeated route; and
a processor that executes computer-executable instructions associated with at least one of the identifier component, discovery component, or update component.

2. The system of claim 1, further comprising a resource optimization component that activates a geo-fence along the repeated route only at an appropriate time, as travel progresses along the repeated route, to conserve resources of a user mobile device.

3. The system of claim 1, further comprising a data collection component that collects data to create history related to identification of the repeated route and repeated user actions along the repeated route.

4. The system of claim 1, wherein each of the geo-fences is activated only at an appropriate time to conserve resources in a user mobile device.

5. The system of claim 1, wherein the geo-fence component removes a geo-fence associated with a point of interest from a monitored list of geo-fences when travel on the repeated route will not lead to the point of interest.

6. The system of claim 1, wherein the fixed geographical route is identified from a group of fixed routes based on at least one of user heading, user location, or time.

7. The system of claim 1, wherein the identifier component dynamically identifies when travel deviates from the repeated route.

8. A computer-implemented method, comprising acts of:
identifying travel of a user along a fixed geographical route as a repeated route of travel, the repeated route of travel defined according to repeated route information;
identifying geo-fences along the fixed route, the geo-fences defined according to geo-fence information;
associating the geo-fences with the repeated route of travel;
detecting deviation from the repeated route of travel based on at least one of the repeated route information or the associated geo-fence information; and
utilizing a processor that executes instructions stored in memory to perform at least one of the acts of identifying, associating, or detecting.

9. The method of claim 8, further comprising updating the geo-fence information as to new or removed geo-fences along the repeated route of travel.

10. The method of claim 8, further comprising identifying and storing user actions along the fixed route as routine actions information.

11. The method of claim 8, further comprising updating the geo-fence information to eliminate geo-fences along the repeated route of travel that are no longer relevant to conserve resources of a user device.

12. The method of claim 8, further comprising creating a history of repeated route information and geo-fence information for a user along the repeated route of travel.

13. The method of claim 8, further comprising identifying the fixed route from possible routes based on at least one of location, heading, or time.

14. The method of claim 8, further comprising modifying a priority of a geo-fence based on an identified route.

15. A computer-implemented method, comprising acts of:
identifying a repeated route of travel of a user from relevant fixed geographical routes, the repeated route of travel defined according to repeated route information;
identifying geo-fences along the fixed route, the geo-fences defined according to geo-fence information that is associated with the repeated route information;
updating the geo-fence information as to new or removed geo-fences along the repeated route of travel; and
utilizing a processor that executes instructions stored in memory to perform at least one of the acts of identifying or updating.

16. The method of claim 15, further comprising dynamically detecting deviation from the repeated route of travel based on at least one of the repeated route information or the associated point-of-interest information.

17. The method of claim 15, further comprising identifying user actions along the fixed route as routine actions information, and storing the routine actions information in association with repeated route information and geo-fence information as history information of user travel along the repeated route of travel.

18. The method of claim 15, further comprising modifying priority of a geo-fence on a limited list of geo-fences associated with the repeated route information.

19. The method of claim 15, further comprising managing device resources based on elimination of non-relevant geo-fences.

20. The method of claim 15, further comprising triggering a geo-fence at an appropriate time and location of a route based on identification of the route as a repeated route and likelihood that the geo-fence will be encountered on the repeated route.
